(19) United States
(12) Patent Application Publication
(10) Pub. No.: US 2006/0092174 A1
(43) Pub. Date: May 4, 2006

(54) Color noise suppressing system

(75) Inventor: Chen Yen Lin, Sindian City (TW)

Correspondence Address: BACON & THOMAS, PLLC, 625 SLATERS LANE, FOURTH FLOOR, ALEXANDRIA, VA, 22314, US

(73) Assignee: Sunplus Technology CO., Ltd., Hsinchu (TW)

(21) Appl. No.: 11/208,602

(22) Filed: Aug. 23, 2005

(30) Foreign Application Priority Data
Oct. 29, 2004 (TW) 093133011

(51) Int. Cl. G09G 5/02

(52) U.S. Cl. 345/604

(57) ABSTRACT

A color noise suppressing system, which has a converter, a saturation compute device, a maximum compute device, and a chroma suppressor. The converter converts a YUV image signal into an RGB image signal. The saturation compute device is connected to the converter for computing a saturation from the RGB image signal and converting the saturation into a first gain. The maximum compute device is connected to the converter for computing a maximum from the RGB image signal and converting the maximum into a second gain. The chroma suppressor is connected to the saturation compute device and the maximum compute device for performing chroma suppression on the YUV image signal according to the first and second gains.

### BACKGROUND OF THE INVENTION

1. Field of the Invention

The invention relates to a color processing system and, more particularly, to a color noise suppressing system for processing abnormal part of an image to suppress color noise.

2. Description of Related Art

Currently, with rapidly developed multimedia technologies, multimedia devices (such as DVD player, digital camera, digital video camera) are in wide spread use. The performance of multimedia devices is essentially based on image quality. However, when taking a scenic photo, because of limited capabilities of devices, color noises may appear on an image. For example, a typical CCD image sensor can easily produce noises at a low light or a slow shutter. In addition, during an image preparation or process (such as an MPEG compression), color spots may appear due to partial image data loss or change.

To overcome this, U.S. Pat. No. 4,680,624 discloses two types of color noise suppression. One is based on chroma degree of a color signal. When the chroma degree is smaller than a threshold level, the color signal is suppressed to reduce color noises. However, such a way also reduces some image saturation or even damages a normal image. The other is based on luma degree. When the luma degree is smaller than a threshold level, the color signal is suppressed to reduce color noises. However, such a way cannot easily reduce color noises in a bight gray scale image. In addition, when suppressing dark color noises such as green spots, a normal blue or red image at a same luma as a green image may be damaged since a green color typically has a higher luma. Therefore, it is desirable to provide an improved color noise suppression to mitigate and/or obviate the aforementioned problems.

### SUMMARY OF THE INVENTION

An object of the invention is to provide a color noise suppressing system, which can eliminate color noises in a bright gray scale image without reducing image saturation.

Another object of the invention is to provide a color noise suppressing system, which can eliminate dark color noises without reducing tints of other dark normal images.

According to a feature of the invention, a color noise suppressing system is provided. The system includes a converter, a saturation compute device and a color suppressor. The converter converts a YUV image signal into an RGB image signal. The saturation compute device is connected to the converter for computing a saturation from the RGB image signal and converting the saturation into a gain. The chroma suppressor is connected to the saturation compute device for performing chroma suppression on the YUV image signal according to the gain.

According to another feature of the invention, a color noise suppressing system is provided. The system includes a converter, a maximum compute device and a color suppressor. The converter converts a YUV image signal into an RGB image signal. The maximum compute device is connected to the converter for computing a maximum from the RGB image signal and converting the maximum into a gain. The chroma suppressor is connected to the maximum compute device for performing chroma suppression on the YUV image signal according to the gain.

According to a further feature of the invention, a color noise suppressing system is provided. The system includes a converter, a saturation compute device, a maximum compute device and a chroma suppressor. The converter converts a YUV image signal into an RGB image signal. The saturation compute device is connected to the converter for computing a saturation from the RGB image signal and converting the saturation into a first gain. The maximum compute device is connected to the converter for computing a maximum from the RGB image signal and converting the maximum into a second gain. The chroma suppressor is connected to the saturation compute device and the maximum compute device for performing chroma suppression on the YUV image signal according to the first and second gains.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a color processing apparatus including an embodiment of a color noise suppressing system according to the invention;

FIG. 2 is a graph of a corrected saturation to first gain conversion curve according to the invention;

FIG. 3 is a graph of a RGB maximum to second gain conversion curve according to the invention;

FIG. 4 is a schematic diagram of another embodiment of a color noise suppressing system according to the invention; and

FIG. 5 is a schematic diagram of a further embodiment of a color noise suppressing system according to the invention.

### DETAILED DESCRIPTION OF THE PREFERRED EMBODIMENT

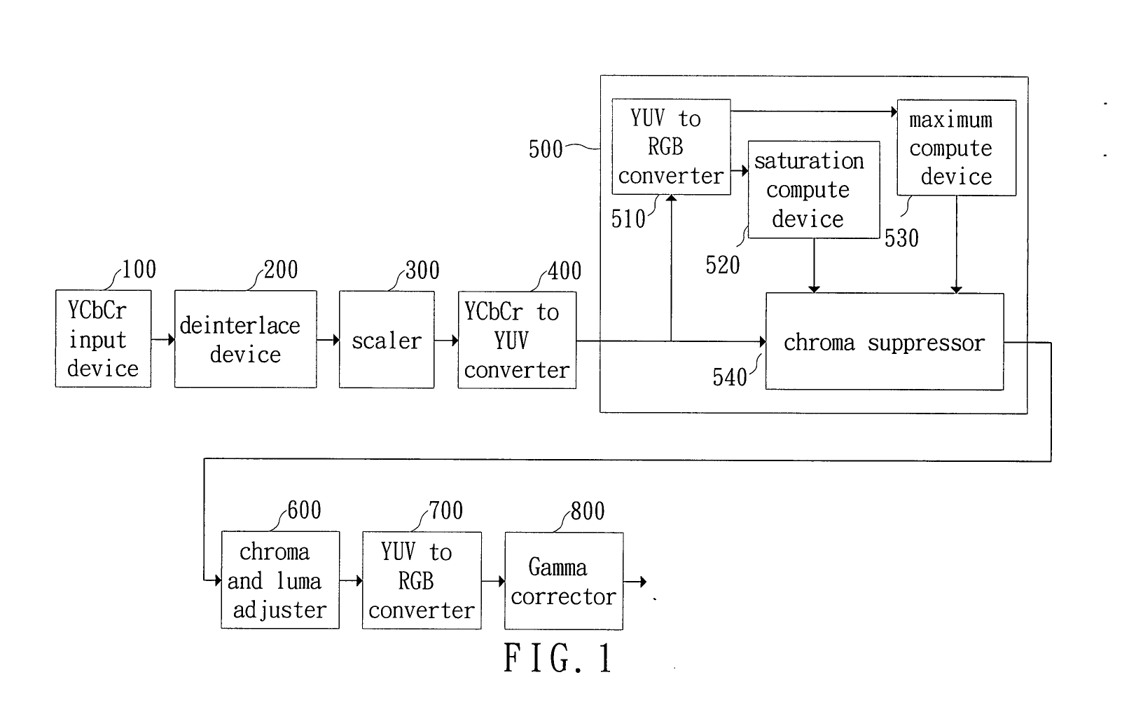

FIG. 1 is a schematic diagram of a color processing apparatus including an embodiment of a color noise suppressing system 500 according to the invention. As shown in FIG. 1, a YCbCr input device 100 receives a YCbCr input signal, where Y, Cb and Cr signals range from zero to 255. A deinterlace device 200 converts the input signal from interlaced to progressive format and thus outputs a progressive frame. A scaler 300 enlarges or reduces the progressive frame. A YCbCr to YUV converter 400 converts the progressive frame from YCbCr to YUV format and thus outputs a YUV image signal, where Y signal ranges from zero to 255, and U and V signals range from −128 to 127. The color noise suppressing system 500 performs chroma suppression on the YUV image signal. A chroma and luma adjuster 600 performs chroma and luma adjustment on the YUV image signal after the chroma suppression. A YUV to RGB converter 700 converts the YUV image signal into an RGB image signal after the chroma and luma adjustment. A Gamma corrector 800 performs Gamma correction on the RGB image signal for compensating the non-linear effect of an imaging device (not shown).

The color noise suppressing system 500 connected to the converter 400 includes a YUV to RGB converter 510, a saturation compute device 520, a maximum compute device 530 and a chroma suppressor 540. The converter 510 converts the YUV image signal into the RGB image signal. The saturation compute device 520 is connected to the converter 510 for computing a saturation from the RGB image signal and converting the saturation into a first gain. The maximum compute device 530 is connected to the converter 510 for computing a maximum from the RGB image signal and converting the maximum into a second gain. The chroma suppressor 540 is connected to the saturation compute device 520 and the maximum compute device 530 for performing chroma suppression on the YUV image signal according to the first and second gains.

The saturation compute device 520 computes a saturation S of RGB image signal of each pixel based on the following equation (1):

$$S = 1 - \frac{3 \times min ( R , G , B )}{( R + G + B )} , \qquad ( 1 )$$

where R, G, B are respective red, green, blue values of the pixel, and S ranges from zero to one. Further, a corrected saturation SS is given by the following equation (2):
SS=fix(S×255), (2)
where the function fix( ) takes a closest and smallest integer of the parameter.

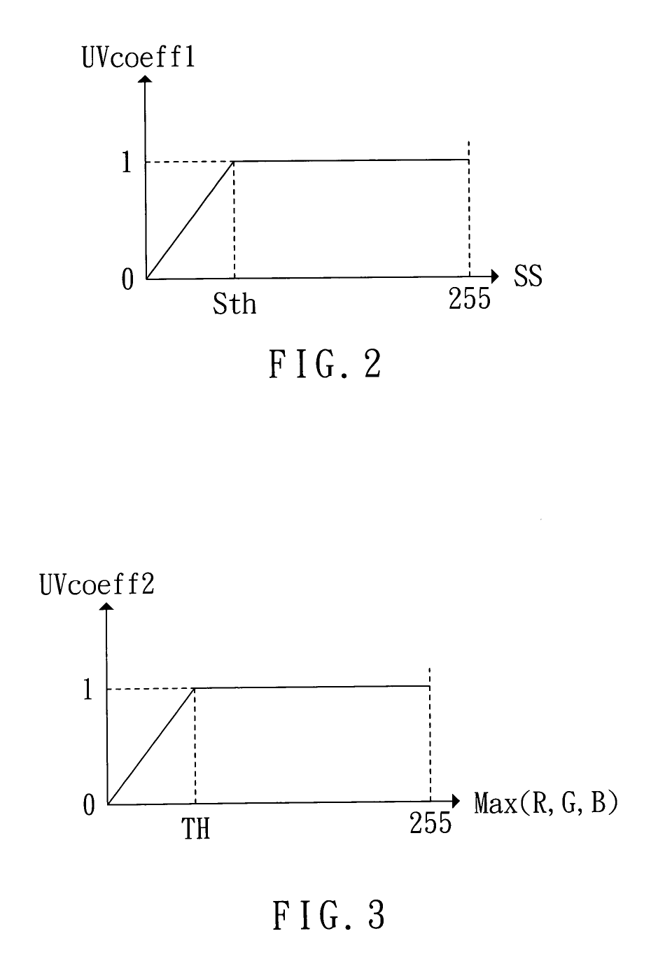

Next, the corrected saturation SS is converted into the first gain UVcoeff1 according to a corrected saturation to first gain conversion curve shown in FIG. 2. When the corrected saturation SS is greater than a predetermined threshold level Sth, the first gain UVcoeff1 is one; otherwise, the first gain UVcoeff1 is increased with the increasing of SS. The curve of FIG. 2 can be replaced by a mathematical equation to compute and obtain the first gain UVcoeff1.

The maximum compute device 530 computes a respective maximum Max(R, G, B) according to RGB image signal of each pixel. Next, the maximum Max(R, G, B) is converted into a second gain UVcoeff2 according to a RGB maximum to second gain conversion curve shown in FIG. 3. As shown in FIG. 3, when the maximum Max(R, G, B) is greater than a predetermined threshold level TH, the second gain UVcoeff2 is one; otherwise, the second gain UVcoef2 is increased with the increasing of Max(R, G, B). The curve of FIG. 3 can be replaced by a mathematical equation to compute and obtain the second gain UVcoeff2.

The chroma suppressor 540 performs a multiplication on U image signal and V image signal of each pixel according to the first gain UVcoeff1 and the second gain Uvcoeff2 of the pixel, respectively. Namely, the device 540 outputs U image signal of the pixel as U*UVcoeff1*UVcoeff2 and V image signal of the pixel as V*UVcoeff1*UVcoeff2, where Uvcoeffl is the first gain, UVcoeff2 is the second gain, and U and V are the U image signal and the V image signal output by the device 400.

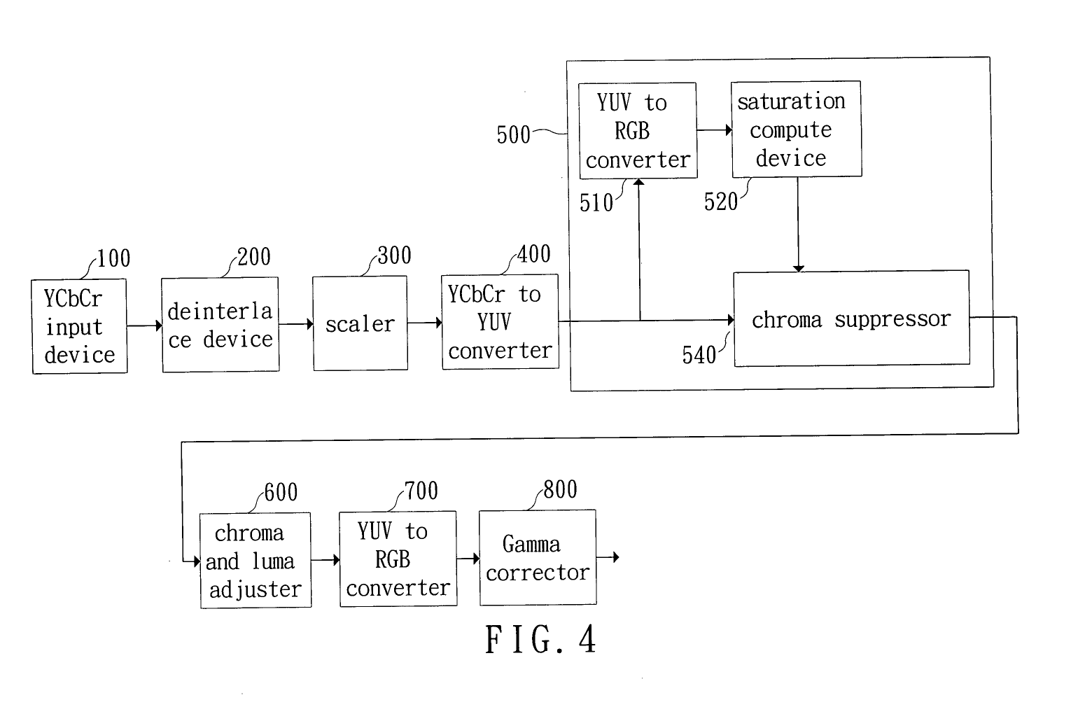

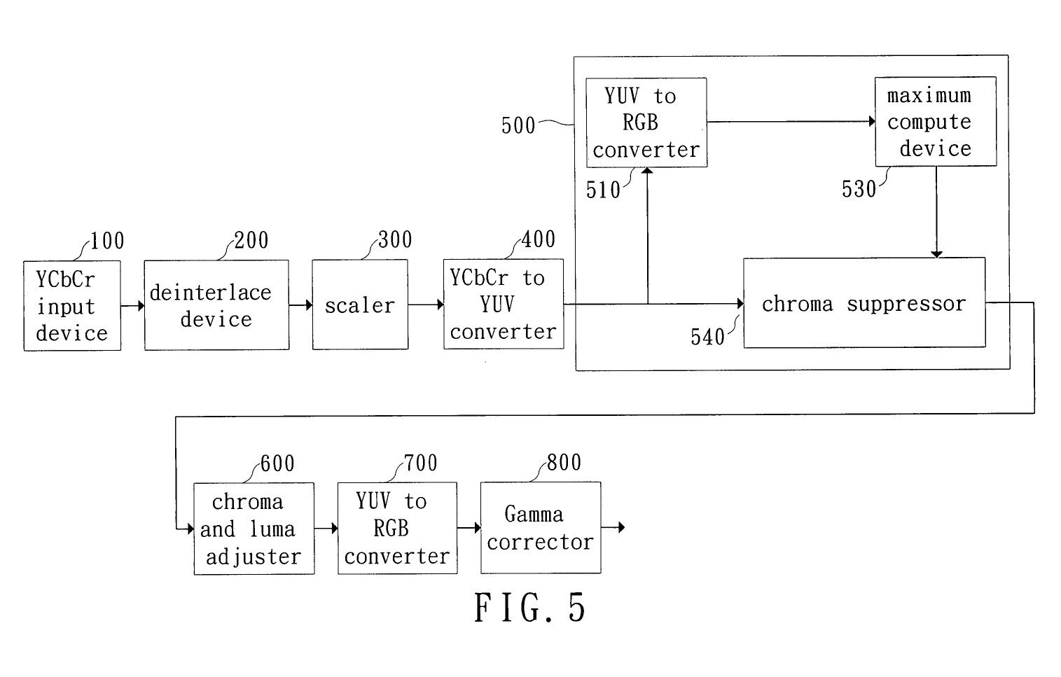

FIG. 4 is a schematic diagram of another embodiment of a color noise suppressing system according to the invention, which is similar to the first embodiment shown in FIG. 1, except that no maximum compute device 530 is required since it essentially functions to eliminate only color noises in a bright gray scale image. FIG. 5 is a schematic diagram of a further embodiment of a color noise suppressing system according to the invention, which is similar to the first embodiment shown in FIG. 1, except that no saturation compute device 520 is required since it essentially functions to eliminate only color noises in a dark gray scale image. Other devices in FIGS. 4 and 5 are identical to those of FIG. 1, and thus a detailed description is deemed necessary.

As cited, the inventive saturation compute device 520 adjusts respective UV value according to RGB signal of each pixel, which can eliminate color noises in a bright gray scale image without reducing any image saturation, as cited in the prior art. In addition, the inventive maximum compute device 530 adjusts respective UV value according to a maximum RGB signal of each pixel, which can easily eliminate color noises in a dark gray scale image without reducing luma of other colors, i.e., blue and red, as cited in the prior art.

Although the present invention has been explained in relation to its preferred embodiment, it is to be understood that many other possible modifications and variations can be made without departing from the spirit and scope of the invention as hereinafter claimed.

What is claimed is:

1. A color noise suppressing system, comprising:
a converter, which converts a YUV image signal into an RGB image signal;
a saturation compute device, which is connected to the converter for computing a saturation from the RGB image signal and converting the saturation into a gain; and
a chroma suppressor, which is connected to the saturation compute device for performing chroma suppression on the YUV image signal according to the gain.

2. The system as claimed in claim 1, wherein the chroma suppressor performs a multiplication respectively on U and V image signals of the YUV image signal according to the gain, thereby suppressing chroma image signal of the YUV image signal.

3. The system as claimed in claim 1, wherein the saturation compute device converts the saturation into the gain according to a conversion equation.

4. The system as claimed in claim 3, wherein the conversion equation is represented as a conversion curve.

5. The system as claimed in claim 4, wherein in the conversion curve, the gain equals to one when the saturation is greater than a predetermined threshold level; otherwise, the gain increases with an increase of the saturation.

6. A color noise suppressing system, comprising:
a converter, which converts a YUV image signal into an RGB image signal;
a maximum compute device, which is connected to the converter for computing a maximum from the RGB image signal and converting the maximum into a gain; and
a chroma suppressor, which is connected to the maximum compute device for performing chroma suppression on the YUV image signal according to the gain.

7. The system as claimed in claim 6, wherein the chroma suppressor performs a multiplication respectively on U and V image signals of the YUV image signal according to the gain, thereby suppressing chroma image signal of the YUV image signal.

8. The system as claimed in claim 6, wherein the maximum compute device converts the maximum into the gain according to a conversion equation.

9. The system as claimed in claim 8, wherein the conversion equation is represented as a conversion curve.

10. The system as claimed in claim 9, wherein in the conversion curve, the gain equals to one when the maximum is greater than a predetermined threshold level; otherwise, the gain increases with an increase of the maximum.

11. A color noise suppressing system, comprising:
a converter, which converts a YUV image signal into an RGB image signal;
a saturation compute device, which is connected to the converter for computing a saturation from the RGB image signal and converting the saturation into a first gain;
a maximum compute device, which is connected to the converter for computing a maximum from the RGB image signal and converting the maximum into a second gain; and
a chroma suppressor, which is connected to the saturation compute device and the maximum compute device for performing chroma suppression on the YUV image signal according to the first and second gains.

12. The system as claimed in claim 11, wherein the chroma suppressor performs a multiplication respectively on U and V image signals of the YUV image signal according to the first and second gains, thereby suppressing chroma image signal of the YUV image signal.

13. The system as claimed in claim 11, wherein the saturation compute device converts the saturation into the first gain according to a conversion equation.

14. The system as claimed in claim 13, wherein the conversion equation is represented as a conversion curve.

15. The system as claimed in claim 14, wherein in the conversion curve, the first gain equals to one when the saturation is greater than a first threshold level; otherwise, the gain increases with an increase of the saturation.

16. The system as claimed in claim 11, wherein the maximum compute device converts the maximum into the second gain according to a conversion equation.

17. The system as claimed in claim 16, wherein the conversion equation is represented as a conversion curve.

18. The system as claimed in claim 17, wherein in the conversion curve, the second gain equals to one when the maximum is greater than a second threshold level; otherwise, the second gain increases with an increase of the maximum.
